(19) United States
(12) Patent Application Publication
(10) Pub. No.: US 2016/0297258 A1
(43) Pub. Date: Oct. 13, 2016

(54) TYRE WITH AN IMPROVED JOINT BETWEEN THE SIDEWALLS AND CORRESPONDING ABRASION GUM STRIPS

(71) Applicants: Marco TOSCANO, Roma (IT); BRIDGESTONE CORPORATION, Tokyo (JP)

(72) Inventor: Marco TOSCANO, Roma (IT)

(73) Assignee: BRIDGESTONE CORPORATION, Tokyo (JP)

(21) Appl. No.: 15/032,744

(22) PCT Filed: Jan. 27, 2015
(86) PCT No.: PCT/IB2015/050604

§ 371 Date: Apr. 28, 2016

(30) Foreign Application Priority Data
Jan. 31, 2014 (IT) RM2014A000048

(51) Int. Cl. B60C 15/06; B60C 9/02; B29D 30/48; B60C 15/00; B29D 30/72; B60C 11/00; B60C 13/00

(52) U.S. Cl. CPC B60C 15/06; B60C 11/00; B60C 9/02; B60C 13/00; B60C 15/0009; B29D 30/72; B29D 30/48; B60C 2015/0614; B29D 2030/486; B29K 2021/00

(57) ABSTRACT

A tyre (1) having: an at least partially turned-up body ply (3); two beads (4) arranged on opposite sides of the body ply (3) and surrounded by the body ply (3); a tread (7) supported by the body ply (3); two side walls (11) arranged outside the body ply (3) between the tread (7) and the beads (4); and two abrasion gum strips (12) located externally below the sidewalls (11) and at the beads (4); wherein a joining surface (13) between each side wall (11) and the corresponding abrasion gum strip (12) has in cross-section a “U”-like shape (FIG. 3).

### FIELD OF THE ART

The present invention relates to a tyre.

The present invention finds advantageous application in a tyre for agricultural use (AGR tyre), thereto the following description will refer explicitly without losing generality due to this. It is important observing that under the definition “tyre for agricultural use” a tyre is meant destined to be used in working vehicles operating on grounds without asphalting, then a “tyre for agricultural use” is both a tyre for agricultural machines, and a tyre for earth-moving machines and the like.

### PRIOR ART

A tyre for agricultural use comprises a toroidal body, which is constituted by at least a body ply partially turned-up on itself and thus having on the sides two layers overlapped each other. On the opposite sides of the body two annular beads are disposed, each one is surrounded by the body ply. The body supports an annular tread with the interposition of a tread belt. Inside the body ply an innerliner is arranged, which is air-impermeable, it constitutes an inner coating and it has the function of keeping the air inside the tyre to maintain over time the inflation pressure of the tyre. The body ply supports a pair of Side Walls (SW) arranged outside the body ply between the tread and the beads. At last, the body ply supports a pair of Abrasion Gum Strips (AGS) located externally below the sidewalls and at the beads; when the tyre is assembled on the circle the abrasion gum strips are arranged in contact with the circle edges, then the abrasion gum strips are made of a mixture of gum having a high resistance to abrasion.

Usually, each side wall and the corresponding abrasion gum strip form one single indivisible element which is implemented by means of a procedure of co-extruding at least two different gum mixtures, respectively constituting the side wall and the abrasion gum strip. In other words, each side wall and the corresponding abrasion gum strip are co-extruded to result firmly joined as from the beginning (that is even before the tyre curing).

In the known tyres for agricultural use, the joining surface between each side wall and the corresponding abrasion gum strip has still in cross (axial) section a linear course. In most known tyres for agricultural use, the joining surface between each side wall and the corresponding abrasion gum strip is oriented radially from inwards outwards, that is it extends from an axially outer and radially further inner end (that is radially nearer to the bead) to an axially inner and radially further outer end (that is radially farer from the bead). In some known tyres for agricultural use, the joining surface between each side wall and the corresponding abrasion gum strip is oriented in opposite way from outwards inwards, that is it extends from an axially outer and radially further outer end (that is radially farer from the bead) to an axially inner and radially further inner end (that is radially nearer to the bead).

EP 0 958 946 describes a tyre of the above-mentioned type.

The purpose of all manufacturers of tyres for agricultural use is to succeed in diminishing the tyre mass (that is the overall quantity of the materials used for the construction of the tyre itself) by maintaining yet an adequately long operating life (that is by avoiding that in the tyre ruptures prematurely form invalidating the use of the tyre itself).

### DESCRIPTION OF THE INVENTION

The object of the present invention is to provide a tyre, which has an adequately long operating life, it has a limited mass and, at the same time, it is easy and economical to be implemented.

According to the present invention a tyre is provided according to what established by the enclosed claims.

### BRIEF DESCRIPTION OF THE DRAWINGS

The present invention will be now described by referring to the enclosed drawings, which illustrate a not limiting embodiment example, wherein:

FIG. 1 is a schematic cross-section, with removed portions for sake of clarity of portion of a tyre implemented according to the present invention;

FIG. 2 is a view in enlarged scale of an area of the bead of the tyre of FIG. 1; and

FIG. 3 is a view in enlarged scale of an area of the bead of an alternative embodiment of the tyre of FIG. 1.

### PREFERRED EMBODIMENTS OF THE INVENTION

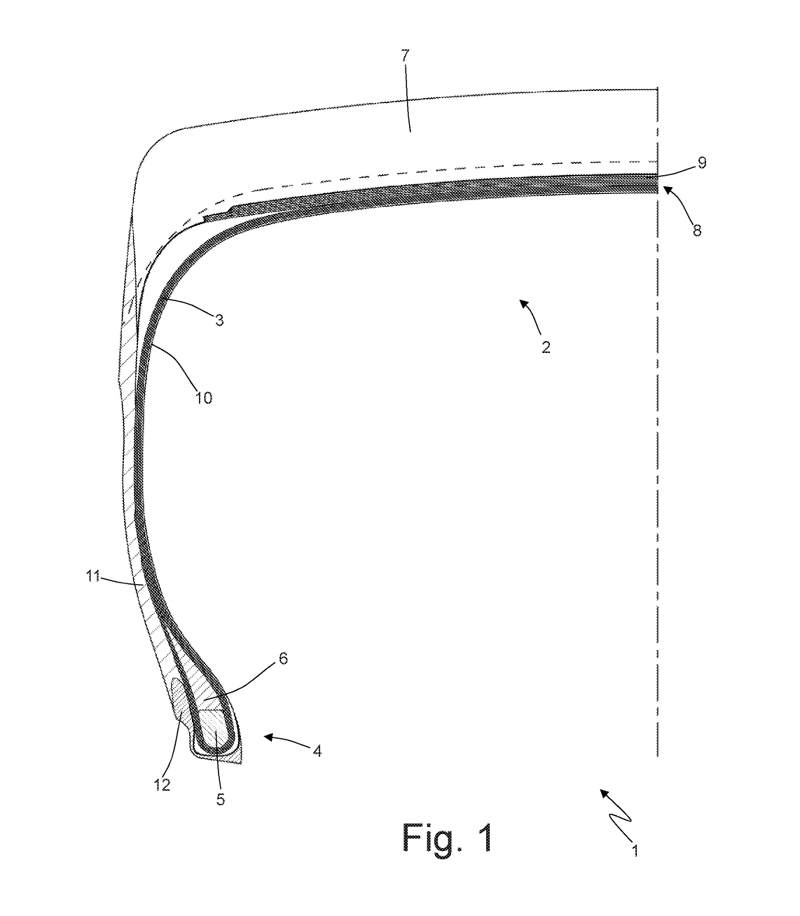

In FIG. 1, a tyre for agricultural use is designated as a whole with number 1, comprising a toroidal body 2, which is constituted by a body ply 3 partially turned-up on itself.

On the opposite sides of the body 2 two annular beads 4 are arranged, each one thereof is surrounded by the body ply 3 and has a bead core 5 reinforced with a number of rounds of a metal wire and a bead filler 6.

The body 2 supports an annular tread 7; between the body 2 and the tread 7 a tread belt 8 is interposed, which comprises one or more tread plies 9. Each tread ply 9 comprises a number of (not illustrated) strings, which are immersed in a rubber band, they are arranged side-by-side with a determined pitch and form a tilting angle determined with an equatorial plane of the tyre 1.

Inside the body ply 3 an innerliner 10 is disposed which is air-impermeable, it constitutes an inner coating and it has the function of keeping the air inside the tyre 1 to maintain over time the inflation pressure of the tyre 1.

The body ply 3 supports a pair of side walls 11 arranged outside the body ply 3 between the tread 7 and the beads 4.

At last, the body ply 3 supports a pair of Abrasion Gum Strips 12 (AGS) located externally below the sidewalls 11 and at the beads 4 (even above the innerliner 10). When the tyre 1 is assembled on the circle, the abrasion gum strips 12 are arranged in contact with the edges of the circle and they have the function of protecting the beads 4 from the abrasion action exerted by the circle; consequently, the abrasion gum strips 12 are made of a mixture of hard gum having a high resistance to abrasion.

Obviously, the real tyre 1 even includes additional completely known and conventional components (for example the “cap ply” and the “Tread Ply Insert—TPI”) which by sake of simplicity have not been illustrated and described.

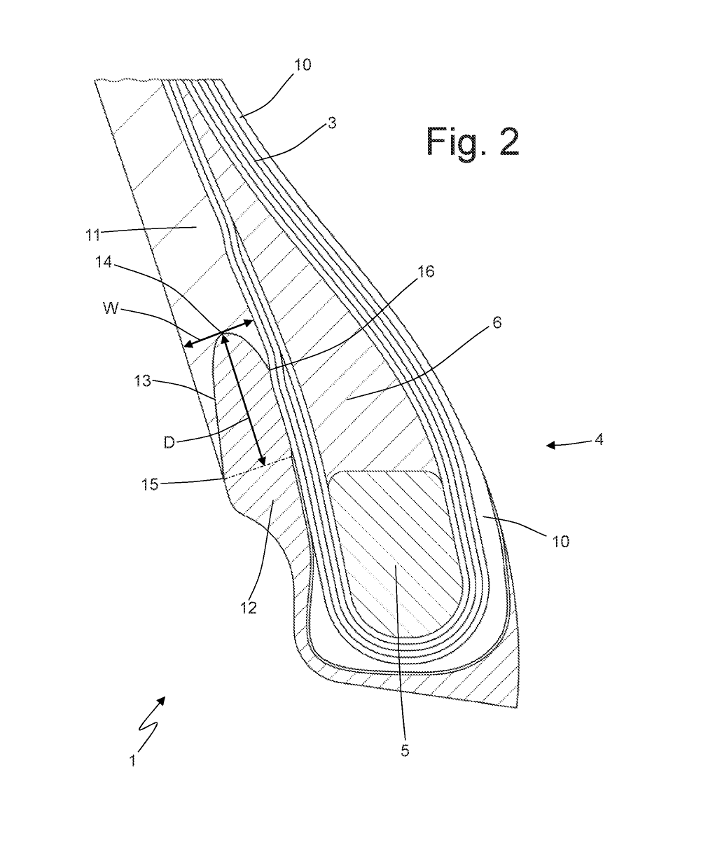

As better illustrated in FIG. 2, each side wall 11 and the corresponding abrasion gum strip 12 belong to a single combined element (that is they form a single monolithic element) which is implemented by means of a procedure of co-extruding at least two mixtures of different gums and respectively constituting the side wall 11 and the abrasive gum strip 12. In other words, each side wall 11 and the corresponding abrasion gum strip 12 are co-extruded together to result firmly joined as from the beginning (that is even before the curing of the tyre 1).

Between each side wall 11 and the corresponding abrasion gum strip 12 a joining surface 13 is defined, which constitutes the area wherein the lower (that is radially inner) end of the side wall 11 touches (that is joins with) the upper (that is radially outer) end of the abrasion gum strip 12. According to what illustrated in FIG. 2, the joining surface 13 between each side wall 11 and the corresponding abrasion gum strip 12 has in cross (that is axial) section a “U”-like shape.

In the embodiment illustrated in FIG. 2, the joining surface 13 between each side wall 11 and the corresponding abrasion gum strip 12 has in cross (that is axial) section a “U”-like shape oriented towards the bead 4; in other words, the joining surface 13 between each side wall 11 and the corresponding abrasion gum strip 12 has a vertex (cuspid) 14 which is arranged further outwards radially than the two ends 15 and 16 of the joining surface 13 itself. According to an alternative not illustrated embodiment, the joining surface 13 between each side wall 11 and the corresponding abrasion gum strip 12 has in cross (that is axial) section a “U”-like shape oriented towards the tread 7 (that is overturned with respect to what illustrated in FIG. 2); in other words, the joining surface 13 between each side wall 11 and the corresponding abrasion gum strip 12 has a vertex 14 which is arranged further inwards radially than the two ends 15 and 16 of the joining surface 13 itself.

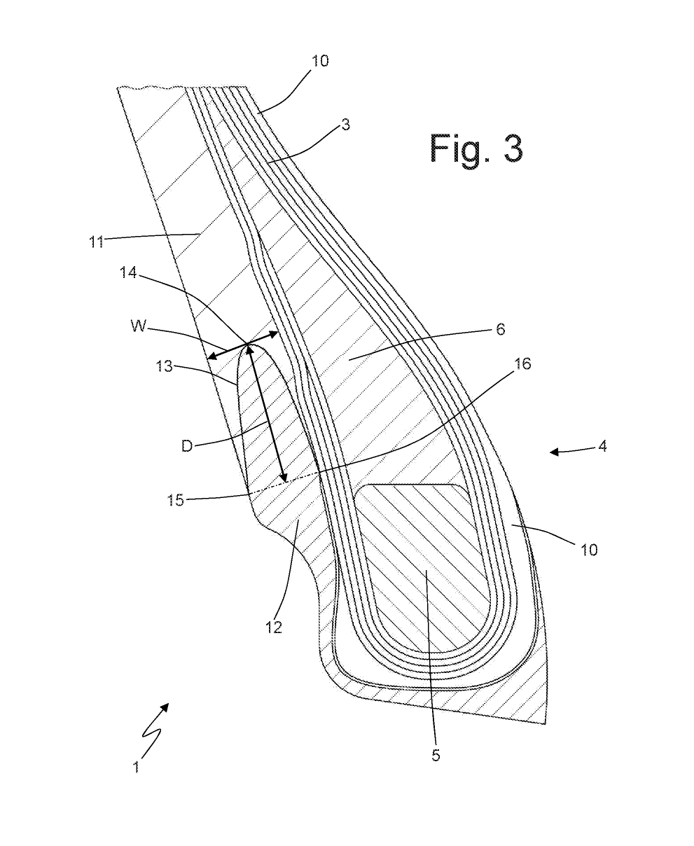

In the embodiment illustrated in FIG. 2, an axially outer end 15 of the joining surface 13 between each side wall 11 and the corresponding abrasion gum strip 12 is arranged further inwards radially (that is radially nearer to the bead 4) than an axially inner end 16 of the joining surface 13 itself. According to an alternative embodiment illustrated in FIG. 3, the axially outer end 15 of the joining surface 13 between each side wall 11 and the corresponding abrasion gum strip 12 is arranged radially at the same height of the axially inner end 16 of the joining surface 13 itself. According to an additional not illustrated embodiment, the axially outer end 15 of the joining surface 13 between each side wall 11 and the corresponding abrasion gum strip 12 is arranged further outwards radially (that is radially farer from the bead 4) than the axially inner end 16 of the joining surface 13 itself.

According to a preferred embodiment, a radial distance D between the vertex 14 of the joining surface 13 between each side wall 11 and the corresponding abrasion gum strip 12 and the end 15 or 16 radially farer from the vertex of the joining surface 13 itself is at least equal to the axial thickness W of the side wall 11 at the vertex 14 of the joining surface 13; in the embodiment illustrated in FIG. 2, the end 15 radially farer from the vertex 14 of the joining surface 13 is the axially outer end 15, whereas in the embodiment illustrated in FIG. 3, the two ends 15 and 16 of the joining surface 13 have substantially the same radial distance from the vertex 14.

The fact that in each joining surface 13 the distance D is at least equal to the axial thickness W contributes to optimize the distribution of mechanical stresses at the joining surface 13 itself.

According to a preferred embodiment, the radius of the joining surface 13 between each side wall 11 and the corresponding abrasion gum strip 12 at its own vertex 14 equals at least equal to 75% of the radius of the osculating circle corresponding to the vertex 14 of the parabola through both the vertex 14, and both ends 15 and 16 of the joining surface 13 itself; such correlation contributes to optimize the distribution of the mechanical stresses at the joining surface 13.

The above-described tyre 1 has several advantages.

First of all, in the above-described tyre 1 the particular shape of the joining surface 13 between each side wall 11 and the corresponding abrasion gum strip 12 allows reducing the mechanical stresses that upon use originate in this area of the tyre 1. In other words, in the above-described tyre 1 the particular shape of the joining surface 13 between each side wall 11 and the corresponding abrasion gum strip 12 allows reducing the frequency and the size of possible cracks which can generate upon use in this area of the tyre 1. In this way, the above-described tyre 1 has a considerably longer duration, that is a useful life, than an analogous known tyre wherein the joining surface between each side wall and the corresponding abrasion gum strip is of conventional type (that is it has in cross-section a linear course). Therefore, by keeping the duration, that is the useful life, unaltered with respect to an analogous known tyre, the above-described tyre 1 results lighter as it is possible reducing the thickness (that is the mass) of the side walls 11 and of the abrasive gum strips 12.

Furthermore, the above-described tyre 1 is simple to be constructed as the modes for implementing the junction between each side wall 11 and the corresponding abrasion gum strip 12 do not suffer from any significant modification with respect to an analogous known tyre; in fact, in order to vary the shape of the joining surface 13 between each side wall 11 and the corresponding abrasion gum strip 12 it is sufficient to shape suitably the extrusion mould which is used to co-extrude together the side wall 11 and the corresponding abrasion gum strip 12.

1. A tyre comprising:
a body ply, which is at least partially turned-up;
two beads arranged on opposite sides of the body ply and surrounded by the body ply;
a tread supported by the body ply;
two sidewalls arranged outside the body ply between the tread and the beads; and
two abrasion gum strips, each arranged externally below a respective sidewall of said two sidewalls and at a respective bead of said two beads,
wherein, between each of said two sidewalls and the respective abrasion gum strip, a joining surface is defined, which joining surface extends, in cross section, between an axially outer first end and an axially inner second end,
wherein each joining surface, in cross-section, has a “U”-like shape.

2. The tyre according to claim 1, wherein each joining surface has in cross-section a “U”-like shape oriented towards a respective bead.

3. The tyre according to claim 1, wherein each joining surface has in cross-section a “U”-like shape oriented towards the tread.

4. The tyre according to claim 1, wherein said axially outer first end of each joining surface is arranged further inwards radially with respect to said axially inner second end of the joining surface.

5. The tyre according to claim 1, wherein said axially outer first end of each joining surface is arranged further outwards radially with respect to said axially inner second end of the joining surface.

6. The tyre according to claim 1, wherein said axially outer first end of each joining surface is arranged radially at the same height as said axially inner second end of the joining surface.

7. The tyre according to claim 1, wherein a radial distance between a vertex of each joining surface and the end of the joining surface radially farther from the vertex is at least equal to an axial thickness of the respective sidewall at the vertex of the joining surface.

8. The tyre according to claim 1, wherein a radius of each joining surface at a vertex thereof equals at least 75% of a radius of an osculating circle corresponding to the vertex of a parabola passing through both the vertex and both ends of the joining surface.

9. The tyre according to claim 1, wherein each joining surface has in cross-section a “U”-like shape having a parabolic course.

10. The tyre according to claim 1, wherein the tyre is for agricultural use.
